(19) United States
(12) Patent Application Publication
(10) Pub. No.: US 2005/0217178 A1
(43) Pub. Date: Oct. 6, 2005

(54) Fuel reforming device

(75) Inventor: Takashi Aoyama, Yokohama-shi (JP)

Correspondence Address: MCDERMOTT WILL & EMERY LLP, 600 13TH STREET, N.W., WASHINGTON, DC, 20005-3096, US

(73) Assignee: NISSAN MOTOR CO., LTD., Yokohama-shi, Kanagawa (JP)

(21) Appl. No.: 10/518,494

(22) PCT Filed: May 28, 2003
(86) PCT No.: PCT/JP03/06662

§ 371 Date: Dec. 20, 2004

(30) Foreign Application Priority Data
Jun. 20, 2002 (JP) 2002-180433

(51) Int. Cl. H01M 8/06; B01J 8/00

(52) U.S. Cl. 48/127.9; 429/19; 422/211

(57) ABSTRACT

A fuel reforming device generates reformate gas containing a large amount of hydrogen by reforming a mixture of a hydrocarbon fuel and air, and supplies the reformate gas to a fuel cell stack (14). The fuel reforming device comprises a fuel injector (1) injecting the hydrocarbon fuel into a fuel mixing chamber (24), first and second air distribution valves (10, 11) supplying air to the fuel mixing chamber (24), and a reformer (5) which generates reformate gas by making the air-fuel mixture supplied from the fuel mixing chamber (24) react in the presence of a reforming catalyst. The reformer (5) is also provided with an oxidation catalyst. When the fuel reforming device starts operating, a large amount of air is supplied from the first and second air distribution valves (10, 11) to the fuel mixing chamber (24), and the oxidation catalyst in the reformer (5) promotes oxidation of the air-fuel mixture to warm up the reformer (5).

### FIELD OF THE INVENTION

This invention relates to a reforming device which generates reformate gas comprising mainly hydrogen from a hydrocarbon fuel.

### BACKGROUND OF THE INVENTION

JP 2000-191304 published by Japanese Patent Office in 2000 discloses a catalytic combustor formed upstream of a reformer for starting a hydrocarbon fuel reforming device. The catalytic combustor is provided with an electric heater. When the reforming device starts, the catalytic combustor is first heated by the electric heater, and after preheating is complete, fuel and air are supplied to the catalytic combustor and catalyzed combustion is started. Combustion gas is supplied to the reformer and warms up the reformer.

After the reformer has warmed up, by supplying excess fuel to the catalytic combustor, fuel vapor is generated, and the generated fuel vapor is supplied to the reformer to reform the fuel.

This catalytic combustor has therefore the functions of a heater which heats the reformer, and a vaporizer which supplies fuel vapor to the reformer after warm-up.

### SUMMARY OF THE INVENTION

If the reformer has not reached the activation temperature at which it can start a reforming reaction when the catalytic combustor is ready to function as a vaporizer, fuel vapor supplied from the catalytic combustor to the reformer is not reformed. In this case, the fuel vapor may be discharged into the air or heat may be taken from the reformer due to condensation of the fuel vapor in the reformer.

In order to prevent this fault and to shorten the starting time required for the reforming device, the catalyst in the reformer must be activated without fail by the time the vaporizer starts supply of fuel vapor.

It is therefore an object of this invention to shorten the time required for catalyst activation of the fuel reforming device. It is a further object of this invention to smoothly shift from warm-up operation to normal operation of the fuel reforming device.

In order to achieve the above object, this invention provides a fuel reforming device which generates reformate gas comprising hydrogen by reforming a mixture of a hydrocarbon fuel and air. The fuel reforming device comprises a fuel mixing chamber, a fuel injector which injects the hydrocarbon fuel into the fuel mixing chamber, a first air distribution valve which supplies air to the fuel mixing chamber and generates an air-fuel mixture, a second air distribution valve which further supplies air to the air-fuel mixture in the fuel mixing chamber, and a reformer comprising a reforming catalyst which generates reformate gas by causing the air-fuel mixture supplied from the fuel mixing chamber to undergo reforming reaction, and an oxidation catalyst which causes the air-fuel mixture to undergo a catalytic combustion.

The details as well as other features and advantages of this invention are set forth in the remainder of the specification and are shown in the accompanying drawings.

### BRIEF DESCRIPTION OF THE DRAWINGS

FIG. 1 is a schematic diagram of a reforming device according to this invention.

FIG. 2 is a flowchart describing a warm-up routine of the fuel reforming device performed by a controller according to this invention.

FIG. 3 is a timing chart describing variations in the amount of fuel and air supplied to a reformer due to execution of the warm-up routine.

FIG. 4 is a flowchart describing a valve control subroutine performed by the controller.

FIG. 5 is a flowchart describing a control routine of the reforming device during a load increase performed by the controller.

FIG. 6 is a flowchart describing a control routine of the reforming device during shut-down performed by the controller.

FIG. 7 is a flowchart describing a control routine of the reforming device during a load increase performed by a controller according to a second embodiment of this invention.

FIG. 8 is a flowchart describing a control routine of the reforming device during a load increase performed by a controller according to a third embodiment of this invention.

FIG. 9 is a flowchart describing a control routine of the reforming device during shut-down performed by the controller according to a fourth embodiment of this invention.

FIG. 10 is similar to FIG. 1 but showing a fifth embodiment of this invention.

FIG. 11 is similar to FIG. 1, but showing a sixth embodiment of this invention.

FIG. 12 is similar to FIG. 1, but showing a seventh embodiment of this invention.

### DESCRIPTION OF THE PREFERRED EMBODIMENTS

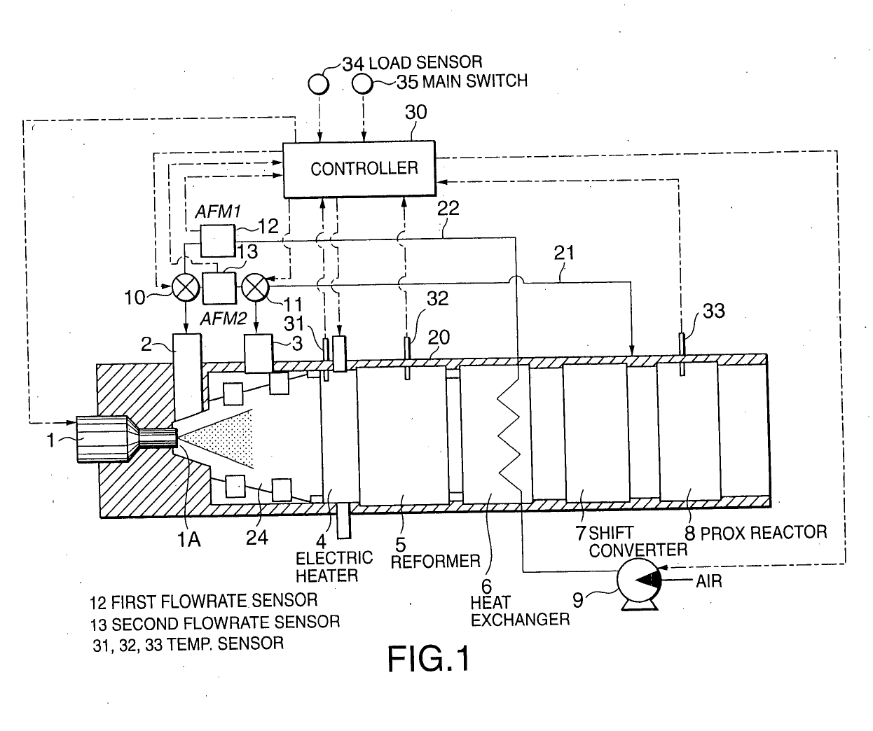

Referring to FIG. 1 of the drawings, a fuel mixing chamber 24, electric heater 4, reformer 5, heat exchanger 6, shift converter 7 and preferential oxidation reactor (PROX reactor) 8 are arranged in order inside a housing 20 of a fuel reforming device used for a fuel cell power plant.

A fuel injector 1 is installed in the fuel mixing chamber 24. The fuel injector 1 injects a hydrocarbon fuel such as gasoline or methanol into the fuel mixing chamber 24 from a nozzle 1A.

A first air supply port 2 and second air supply port 3 which supply air to the injected fuel are provided in the fuel mixing chamber 24. The air is supplied from a blower 9 to the first air supply port 2 via an air supply passage 22 and a first air distribution valve 10. The first air distribution valve 10 makes the remaining air flow into the air supply passage 21. The air supply flowrate of the first air supply port 2 increases, the larger the opening of the first air distribution valve 10 is.

Air is supplied from the air supply passage 21 to a second air supply port 3 via a second air distribution valve 11. The supply flowrate of the second air supply port 3 increases, the larger the opening of the second d air distribution valve 11 is. This air mixes with the fuel spray from the fuel injector 1, and generates an air-fuel mixture in the fuel mixing chamber 24. The opening of the first air supply port 2 is preferably near a nozzle 1A of the fuel injector 1 so that atomization of fuel immediately after it is injected from the nozzle 1A, is promoted. It is also possible to use a compressor instead of a blower 9.

After the air supply passage 21 shunts part of the air in the second air distribution valve 11 to the second air supply port 3, it is connected to a PROX reactor 8.

An air supply flowrate AFM1 to the first air distribution valve 10 is detected by a first flowrate sensor 12, and an air supply flowrate AFM2 to the second air distribution valve 11 is detected by a second flowrate sensor 13, respectively.

The fuel-air mixture generated in the fuel mixing chamber 24 is heated by the electric heater 4, and is sent to the reformer 5 in the gaseous state. It is preferred to also make the heating element of the electric heater 4 support an oxidation catalyst which has a fuel reforming action.

The reformer 5 contains both a reforming catalyst and an oxidation catalyst, or contains a reforming catalyst having a combined oxidation-catalyst function. It is known that the following three kinds of reforming reactions apply to the reforming of hydrocarbon fuel.

Specifically, these are vapor reforming, partial oxidation reforming, and autothermal reforming (ATR)).

Vapor reforming may be represented by the following equation (1).

$${C}_{m} {H}_{m} + m {H}_{2} O -> ( m + \frac{n}{2} ) {H}_{2} + m CO \qquad ( 1 )$$

The reaction of equation (1) is accompanied by reactions shown by the following equations (2) and (3).
3H₂+CO→CH₄+H₂O (2)
2H₂+2CO→CH₄+CO₂ (3)

When the reforming atmosphere is at high temperature, the reaction of equation (1) is mainly performed. Consequently, the concentration of the hydrogen and carbon oxide contained in the reformate gas increases. The reaction of equation (1) is an endothermic reaction, and in order to maintain the reaction, heat must be supplied.

When the reforming atmosphere is at low temperature, the reaction proportions of equations (2) and (3) increase, so the concentrations of hydrogen and carbon monoxide in the reformate gas falls, and the concentrations of methane and water vapor increase. Partial-oxidation reforming is represented by the following equation (4).

$${C}_{m} {H}_{n} + \frac{m }{2} {O}_{2} -> \frac{n}{2} {H}_{2} + m CO \qquad ( 4 )$$

This reaction is an exothermic reaction, and can be maintained by adjusting the fuel vapor supply amount and air supply amount.

Autothermal reforming is a combination of vapor reforming and partial-oxidation reforming which are performed at the same reaction site, and heat exchange between endothermic reactions and exothermic reactions are balanced.

Although the partial oxidation reformer is applied to the reformer 5 of this reforming device, the reformer 5 may be of any type which performs a reforming reaction. Also, all reforming reactions takes place under a rich fuel-air ratio where the fuel concentration is higher than the stoichiometric air fuel ratio.

A heat exchanger 6 is situated downstream of the reformer 5, and preheats the air delivered by the blower 9 with the heat of reformate gas.

The shift converter 7 located downstream of the heat exchanger 6 and PROX reactor 8 are known devices for removing the carbon monoxide (CO) contained in reformate gas. The shift converter 7 converts the carbon monoxide in reformate gas into carbon dioxide (CO₂) using water, and the PROX reactor 8 converts the carbon monoxide in reformate gas into carbon dioxide (CO₂) using the oxygen in the air supplied from the second air distribution valve 11, respectively.

The operations of the fuel injector 1, the first air distribution valve 10, the second air distribution valve 11, the blower 9, and the electric heater 4 are controlled by a controller 30.

Although only the fuel injector 1 is shown in FIG. 1 as a device which performs fuel injection, fuel is supplied to the fuel injector 1 at a constant pressure from a fuel pump, not shown, and the fuel injector 1 injects fuel according to a fuel injection signal from the controller 30. The injection amount of the fuel injector 1 is controlled by controlling the valve-opening time period of the nozzle 1A using a pulse width modulation signal, or by adjusting the opening degree of the nozzle 1A.

The controller 30 comprises a microcomputer provided with a central processing unit (CPU), read-only memory (ROM), random access memory (RAM) and input\output interface (I/O interface). The controller 30 may also comprise plural microcomputers.

To perform this control, the fuel reforming device comprises a temperature sensor 31 which detects the temperature of the electric heater 4, a temperature sensor 32 which detects the temperature of the reformer 5, a temperature sensor 33 which detects the temperature of the PROX reactor 8, a load sensor 34 which detects the power generation load of the fuel cell power plant and a main switch 35 which switches the fuel cell power plant ON or OFF. The detection temperatures of these temperature sensors 31-35 are respectively input into the controller 30 as signals.

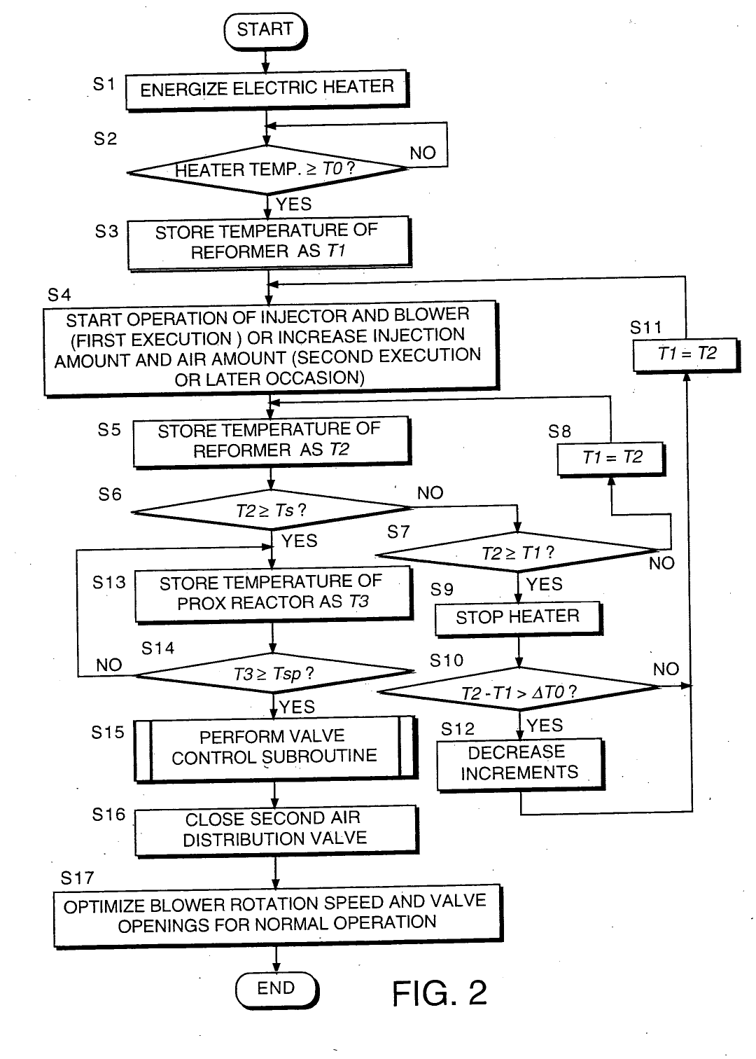

Next, referring to FIG. 2, a warm-up routine of the fuel reforming device performed by the controller 30 will be described. This routine is performed when the main switch 35 is turned ON.

First, the controller 30 energizes the electric heater 4 in a step S1.

In a following step S2, the temperature of the electric heater 4 detected by the temperature sensor 31 is compared with a target temperature T0. The target temperature T0 is a temperature for determining whether or not fuel supply has started. The controller 30 stands by without proceeding to future steps until the temperature of the electric heater 4 reaches the target temperature T0. When the temperature of the electric heater 4 reaches the target temperature T0, the controller 30 reads the temperature of the reformer 5 detected by the temperature sensor 32 in a step S3, and stores it in an internal RAM as a temperature T1.

In a following step S4, fuel injection by the fuel injector 1 and the operation of the blower 9 are started to supply fuel and air to the fuel mixing chamber 24.

When the step S4 is executed for the first time, the target fuel injection amount and a target air supply amount are respectively set to predetermined values. The blower 9, once its operation starts, continues its operation until the processing of a step 17 which will be described later is performed.

When the step S4 is executed for the second time or later, increase in the target fuel injection amount and the target air supply amount as well as the corresponding control of the fuel injector 1, the first distribution valve 10 and the second distribution valve 11 are performed respectively applying predetermined increments. The distribution ratio of the first air distribution valve 10 is regulated so that the fuel-air mixture supplied to the reformer 5 is a lean air-fuel mixture having an air excess factor of 2 to 5. In the processing of the step S4 when it is performed for the second time or later, the control of air supply amount is performed by first regulating the opening of the first air distribution valve 10 and, when the air supply amount is still less than the target air supply amount after the regulation of the opening of the first air distribution valve 10, the opening of the second air distribution valve 11 is then regulated.

A lean air-fuel mixture is supplied to the reformer 5 to perform a catalytic combustion of the air-fuel mixture in the presence of the oxidation catalyst in the reformer 5 to raise the temperature of the reforming catalyst in the reformer 5 as well as to warm up the heat exchanger 6, shift converter 7 and PROX reactor 8 by the heat of the combustion gas.

In a following step S5, the controller 30 again reads the temperature of the reformer 5 detected by the temperature sensor 32, and stores it in the internal RAM as a temperature T2.

In a following step S6, the temperature T2 is compared with a warm-up target temperature Ts of the reformer 5. When the temperature T2 has reached the warm-up target temperature Ts, the controller 30 performs the processing of steps S13-S17. When the temperature T2 has not reached the warm-up target temperature Ts, the controller 30 performs the processing of steps S7-S12. The warm-up target temperature Ts is the temperature at which a partial oxidation reaction can occur in the lean air-fuel mixture, and is generally 200 to 500 degrees centigrade.

In a step S7, the temperature T2 is compared with the temperature T1 before start of fuel supply which was stored in the RAM. When the temperature T2 is lower than the temperature T1, the controller 30, in a step S8, substitutes the value of the temperature T2 for the temperature T1, and repeats the processing from the step S5.

Thus, if the temperature T2 rises above the temperature T1 in the step S7, the controller 30 stops energization of the electric heater 4 in the step S9. The processing of the step S5-S8 means that heating by the electric heater 4 is continued until the temperature of the reformer 5 shows an increase after fuel supply has started. Also, in the step S7, the temperature rise confirms that heat of reaction has definitely been generated in the reformer 5.

Now, after energization of the electric heater 4 is stopped in the step S9, the controller 30, in a step S10, compares a temperature difference T2−T1 with a predetermined temperature difference ΔT0. The predetermined temperature difference ΔT0 is the target value of the temperature rise per unit time of the reformer 5. When the temperature difference T2−T1 exceeds the predetermined temperature difference ΔT0, the catalyst of the reformer 5 may be damaged by thermal shock.

In this case, in a step S12, the controller 30 decreases the increment for the target fuel injection amount and the increment for the target air supply amount which will be applied in the processing of the step S4.

After the processing of the step S12, the controller 30, in a step S11, substitutes the value of the temperature T2 into the temperature T1, and repeats the processing from the step S4. Also, in the step S10, when the temperature difference T2−T1 does not exceed the predetermined temperature difference ΔT0, the controller 30 likewise substitutes the value of the temperature T2 into the temperature T1 in a step S8, and repeats the processing from the step S5.

By repeating the processing of the steps S4-S12, when the temperature T2 of the reformer 5 reaches the warm-up target temperature Ts in the step S6, the controller 30 performs the processing of the steps S13-S17.

In the step S13, the controller 30 reads a temperature T3 of the PROX reactor 8 detected by the temperature sensor 33, and stores it in the internal RAM.

In a following step S14, the controller 30 compares the temperature T3 with a warm-up target temperature TSP of the PROX reactor 8. In general, the warm-up target temperature TSP of the PROX reactor 8 is 80-200 degrees centigrade. Before the temperature T3 reaches the warm-up target temperature TSP of the PROX reactor 8, the controller 30 does not proceed to future steps, but repeats reading of the temperature T3 of the step S13. Here, it is considered that the shift converter 7 situated the upstream has also reached warm-up temperature when the temperature T3 of the PROX reactor 8 reaches the warm-up target temperature TSP.

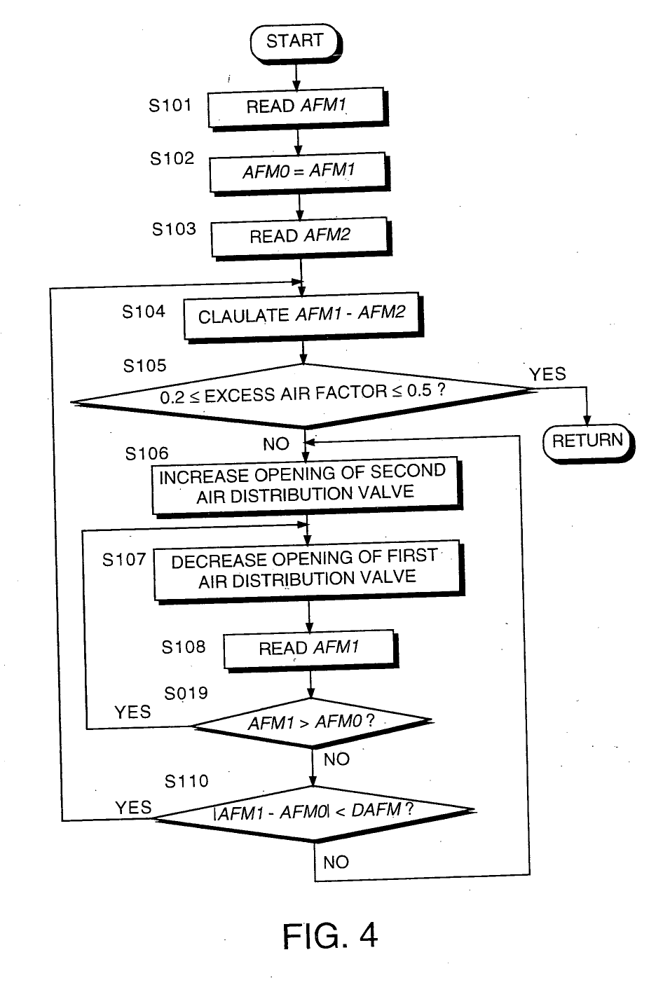

When the temperature T3 reaches the warm-up target temperature TSP of the PROX reactor 8 in the step S14, the controller 30, in a step S15, by performing a subroutine shown in FIG. 4 controls the opening of the first air distribution valve 10 and second air distribution valve 11 so that the air supply amount of the first air supply port 2 is an air supply amount corresponding to a rich air-fuel mixture where the air excess factor lambda is 0.2 to 0.5, while the total air supply amount to the reformer 5 including the supply air amount of the second air supply port 3, is maintained at an air amount corresponding to a lean air-fuel mixture where the air excess factor lambda is 2 to 5.

In a step S16, by making the distribution ratio of the second air distribution valve 11 to the second air supply port 3, zero, air supply from the second air supply port 3 to the reformer 5 is interrupted, and the fuel-air mixture in the reformer 5 is changed from a lean air-fuel mixture where the air excess factor lambda is 2 to 5, to a rich air-fuel mixture where the air excess factor lambda is 0.2 to 0.5.

In a final step S17, the controller 30 respectively controls the rotation speed of the blower 9, the opening of the first air distribution valve 10 and the second air distribution valve 11, to their optimum values for the normal operation of the reforming device. After the processing of the step S17 the controller 30 terminates the routine.

Next, the valve control subroutine performed by the controller 30 in the step S15 will be described referring to FIG. 4.

First, the controller 30 reads an air supply flowrate AFM1 to the first air distribution valve 10 detected by the first flowrate sensor 12 in a step S101.

In a following step S102, the controller 30 stores the air supply flowrate AFM1 to the first air distribution valve 10 as an initial value AFM0 in the RAM.

In a following step S103, the controller 30 reads an air supply amount AFM2 to the second air distribution valve 11 detected by the second flowrate sensor 13.

In a following step S104, the controller 30 subtracts AFM2 from AFM1 to calculate the air supply flowrate of the first air supply port 2.

In a following step S105, it is determined whether or not the ratio of the fuel injection amount of the fuel injector 1 and the air supply amount of the first air supply port 2, corresponds to a rich air-fuel mixture where the air excess factor lambda is 0.2 to 0.5. The fuel injection amount of the fuel injector 1 is controlled by a signal from the controller 30, as mentioned above. Therefore, the fuel injection amount of the fuel injector 1 is already known by the controller 30.

When the determination result of the step S105 is affirmative, the controller 30 terminates the subroutine.

In the step S4 of the routine of FIG. 2 performed prior to execution of this subroutine, a lean air-fuel mixture is generated in the reformer 5 by increasing the distribution ratio from the first air distribution valve 10 to the fuel mixing chamber 24. Therefore, when the determination result of the step S105 is negative, it means that the air supply amount by the first air distribution valve 10 is excessive.

In a Step S106, the controller 30 increases the opening of the second air distribution valve 11 by one step. In a step 107, the opening of the first air distribution valve 10 is decreased by one step. As a result of the processing of the steps S106, S107, the air supply flowrate of the first air supply port 2 decreases relatively to the air supply flowrate of the second air supply port 3.

In a following step S108, the controller 30 again reads the air supply flowrate AFM1 to the first air distribution valve 10 detected by the first flowrate sensor 12.

In a following step S109, the controller 30 compares the air supply flowrate AFM1 to the first air distribution valve 10 with the initial value AFM0 stored in the RAM.

When the air supply flowrate AFM1 to the first air distribution valve 10 exceeds the initial value AFM0, i.e., when the air supply flowrate AFM1 to the first air distribution valve 10 increases as a result of the processing of the steps S106, S107, the controller 30 again returns to the step S107, and decreases the opening of the first air distribution valve 10 by one step. If the opening of the first air distribution valve 10 decreases, i.e., the distribution ratio to the first air supply port 2 is decreased, the air flow rate of the air supply passage 21 is increased, and the air flow resistance thereof will increase, so the air supply flowrate AFM1 to the first air distribution valve 10 decreases as a result.

Also, if the opening of the second air distribution valve 11 is increased, air flow resistance in the air supply passage 21 upstream of the second air distribution valve 11 will decrease, so the air supply flowrate AFM1 to the first air distribution valve 10 increases as a result.

When the processing of the steps S107-S109 is repeated, and the air supply flowrate AFM1 to the first air distribution valve 10 reaches the initial value AFM0 in the Step S109, the controller 30, in a Step S110, compares the absolute value of the difference of AFM1 and AFM0 with a predetermined variation ΔAFM. When the absolute value of the difference of AFM1 and AFM0 is less than the variation ΔAFM, it shows that the air supply flowrate AFM1 to the first air distribution valve 10 is stable near the initial value AFM0. In this case, the controller 30 repeats the processing of the step S104 and subsequent steps. On the other hand, if the absolute value of the difference of AFM1 and AFM0 is not less than the variation ΔAFM in the Step S110, the controller 30 repeats the processing of the Steps S106-S110 until the absolute value of the difference of AFM1 and AFM0 is less than the variation ΔAFM.

In other words, the processing of the steps S104-S110 decreases the air supply flowrate of the first air supply port 2 and increases the air supply flowrate of the second air supply port 3 without varying the air supply flowrate AFM1 to the first air distribution valve 10.

In this way, in a step S105, when the air supply flowrate of the first air supply port 2 is a flowrate corresponding to the aforesaid rich air-fuel mixture where the air excess factor lambda is 0.2 to 0.5, the controller 30 terminates the subroutine.

Hence, when the fuel reforming device is started, the lean air-fuel mixture is first heated by the electric heater 4 and supplied to the reformer 5 such that the temperature of the reformer 5 is raised by generation of heat due to the oxidation of the lean air-fuel mixture. When the temperature of the reformer 5 begins to rise, the electric heater 4 is turned OFF, and the air supply amount to the reformer 5 is regulated so that the temperature of the reformer 5 does not rise too rapidly. When the temperature of the reformer 5 reaches the warm-up target temperature Ts and the temperature of the PROX reactor 8 reaches the warm-up target temperature TSP, the lean air-fuel mixture which was supplied to the reformer 5 is immediately changed over to the original rich air-fuel mixture for reforming.

Thus, the catalyst can be activated in a short time using the reaction heat of oxidation of the lean air-fuel mixture in the reformer 5, while maintaining energization of the heater 4 at the minimum. After verifying that the catalyst temperature of the reformer 5 and the temperature of the PROX reactor 8 have reached the respective warm-up target temperatures, a rich air-fuel mixture for reforming is supplied to the reformer 5. When this rich air-fuel mixture is supplied, the catalysts in the reformer 5 and PROX reactor 8 are activated without fail, and the transition to normal running takes place without delay.

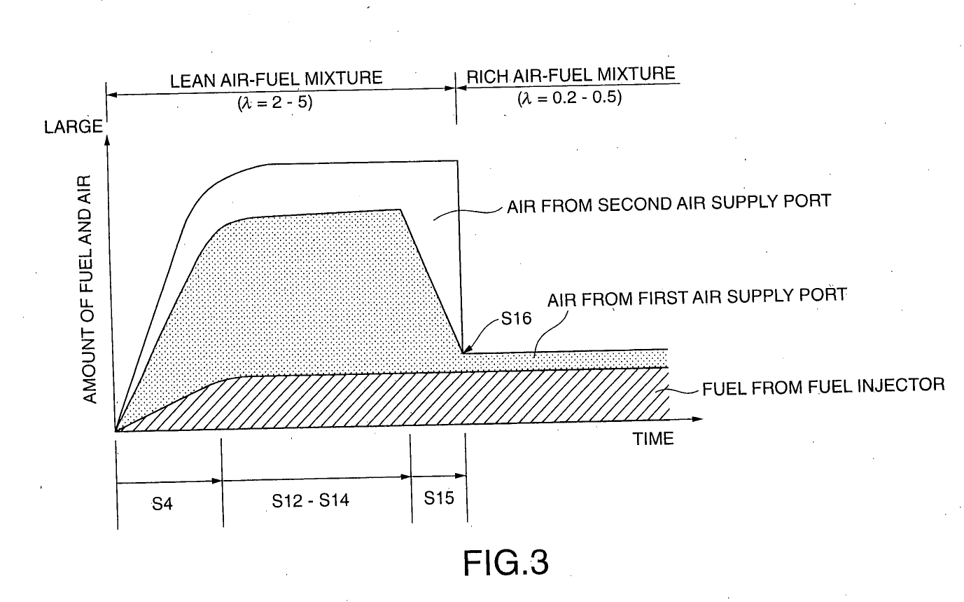

FIG. 3 shows the change of composition of the fuel-air mixture supplied to the reformer 5 during execution of the warm-up routine. First, due to the processing of the Step S4, a large amount of air is supplied from the first air supply port 2 to the fuel mixing chamber 24, and when the fuel injector 1 starts injection of fuel, a lean air-fuel mixture is supplied to the reformer 5. Further, insufficient air is supplied from the second air supply port 3 so that the air excess factor lambda of the lean air-fuel mixture is a target value in the range of 2-5.

During the processing of the Steps S5-S14, supply of this lean air-fuel mixture is maintained, and warm-up of the reformer 5, shift converter 7 and PROX reactor 8 is continued. When warm-up of the PROX reactor 8 is confirmed to be complete in the Step S14, the air supply amount of the first air supply port 2 is reduced to the supply amount in ordinary reforming operation in the step S15, and by increasing the air supply amount of the second air supply port 3, the same lean air-fuel mixture is supplied to the reformer 5.

Then, by stopping the air supply by the second air supply port 3 in the step S16, a change-over is made to a rich air-fuel mixture where the air excess factor lambda is 0.2-0.5. Thereafter, ordinary reforming operation is performed by the reformer 5, the shift converter 7, and the PROX reactor 8, all of which have completed warm-up.

The processing of the step S15 corresponds to preparation to instantaneously change over the concentration of the fuel-air mixture from a lean air-fuel mixture to a rich air-fuel mixture. As a result of the processing of the step S15, when the air supply from the second air supply port 3 to the reformer 5 is interrupted in the step S16, the concentration of the fuel-air mixture immediately changes from a lean air-fuel mixture where the air excess factor lambda is 2 to 5, to a rich air-fuel mixture where the air excess factor is 0.2 to 0.5.

When a fuel-air mixture near the stoichiometric air-fuel ratio is supplied to the reformer 5, the reaction temperature reaches a very high temperature exceeding 2000 degrees centigrade, but by immediately changing from a lean air-fuel mixture to a rich air-fuel mixture in this way, catalyst deterioration or dissolution of the catalyst support or the reformer 5 due to a air-fuel mixture near the stoichiometric air-fuel ratio, can be prevented.

The change-over from a lean air-fuel mixture to a rich air-fuel mixture is performed only by a valve operation, and there is no necessity to vary the air supply amount of the blower 9. In an ordinary rotating type blower, there is an operation response delay, but as the lean air-fuel mixture is changed over to the rich air-fuel mixture only by a valve operation, there is no response delay in the variation of the concentration of the air-fuel mixture even if an ordinary rotating type blower is used for the blower 9.

Also, at other times apart from change-over of the air-fuel mixture, as shown in FIG. 3, air is supplied mainly from the first air supply port 2 near the fuel injector 1, so atomization of the fuel immediately after injection can be efficiently performed using the shear force of the air discharged from the first air supply port 2.

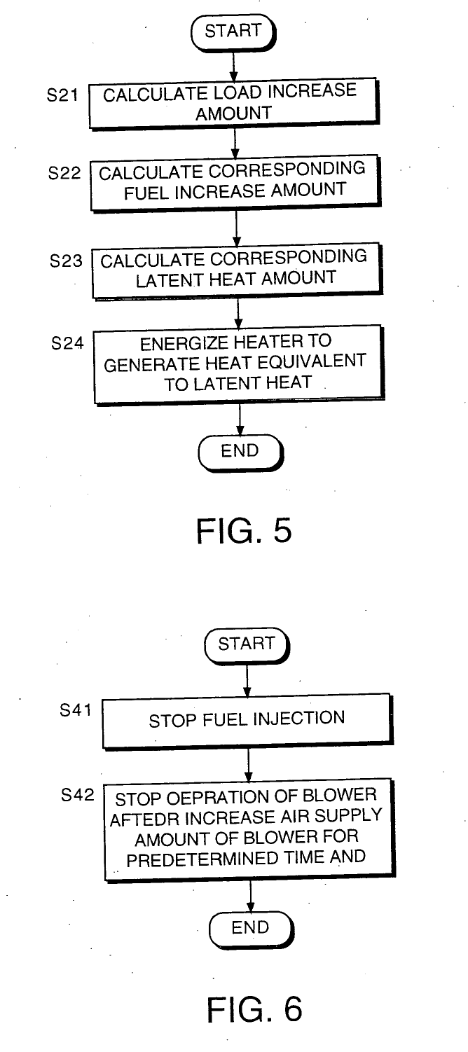

Next, referring to FIG. 5, a routine for controlling the fuel reforming device performed by the controller 30 when this fuel reforming device is operating normally and the power generation load of the fuel cell power plant exceeds the normal load, will be described. This routine is executed when the controller 30 detects a load increase during normal operation of the fuel reforming device.

First, the controller 30 calculates a load increase amount in a step S21. In a following step S22, a fuel increase amount corresponding to the load increase amount is calculated.

In a following step S23, the controller 30 calculates a latent heat amount required to vaporize the fuel increase amount.

In a following step S24, the electric heater 4 is energized so that a heat amount equivalent to the latent heat amount calculated in the step S23, is generated. After the processing of the step S4, the controller 30 terminates the routine.

The air supplied to the reformer 5 is heated by a heat exchanger 6 before supply. Although the fuel injected by the fuel injector 1 is vaporized by the high temperature air supplied from the first air supply port 2, the latent heat amount consumed by vaporization is proportional to the fuel injection amount. Therefore, when the fuel injection amount increases, the heat amount due to the high temperature air from the first air supply port 2 will be insufficient, and vaporization of fuel will become difficult. Hence, when the fuel injection amount increases, a heat amount equivalent to the increased latent heat amount is supplied by the electric heater 4. Although not shown in the flowchart, when the power generation load decreases to the normal load, the controller 30 stops energization of the electric heater 4.

When the fuel injection amount increases according to the power generation load, the heat amount required to vaporize the extra fuel immediately after increase may temporarily exceed the heat amount obtained from the heat exchanger 6, but due to the above routine, even in this case, the heat amount which could not be supplied by the electric heater 4 is compensated, so there is no risk that unvaporized fuel will be supplied to the reformer 5, and temporary decline in the performance of the reformer 5 is prevented.

Next, referring to FIG. 6, a control routine performed by the controller 30 when the operation of the fuel reforming device stops, will be described. This routine is executed when the controller 30 detects that the main switch 35 has changed over from ON to OFF.

In a step S41, the controller 30 stops the injection of fuel by the fuel injector 1.

In a following step S42, after increasing the air supply amount of the blower 9 for a predetermined time, the controller 30 stops operation of the blower 9.

Due to the execution of this routine, when the fuel reforming device stops operation, there is an oxidizing atmosphere in the device including the reformer 5, and fuel remaining inside the device is completely oxidized. Therefore, there is no possibility that unburnt fuel remaining in the device during shutdown or re-starting will be discharged into the outside air, and the exhaust gas composition is always maintained in a desirable state.

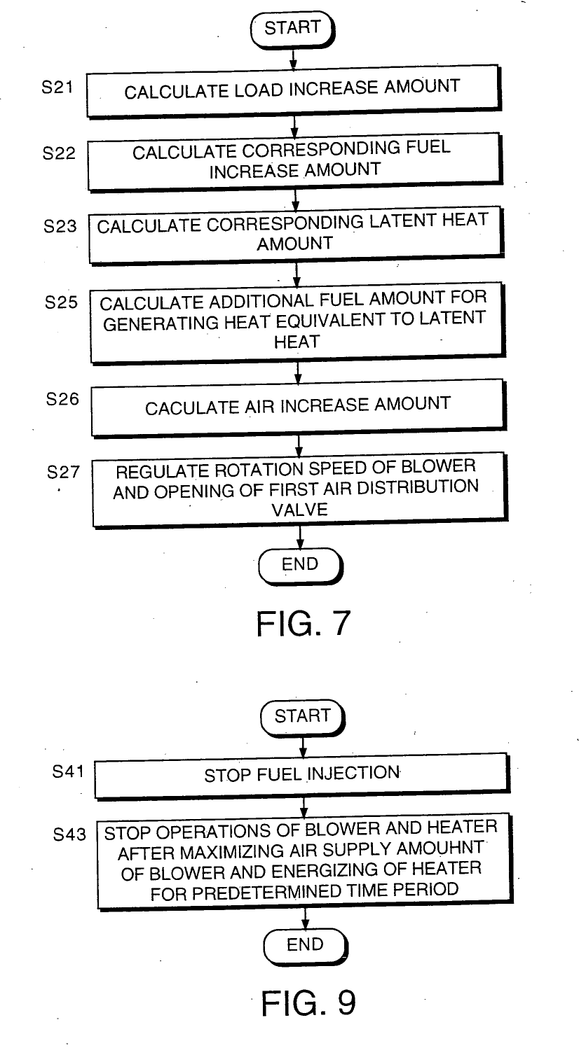

Next, referring to FIG. 7, a second embodiment of this invention will be described.

This embodiment relates to the control when there is an increase in load. The controller 30 performs the routine of FIG. 7 instead of the routine of FIG. 5 of the first embodiment. In this routine, steps S25-S27 are provided instead of the step S24 of the routine of FIG. 5. The remaining details of the other steps are identical to those of the routine of FIG. 5.

In the Step S25, the controller 30 calculates an additional fuel amount required for generating heat equivalent to the latent heat which was calculated in the step S23, by catalytic combustion in the reformer 5.

In the following step S26, the controller 30 calculates an air increase amount to realize the catalytic combustion of the fuel increase amount calculated in the step S22 and the additional fuel amount calculated in the step S25. In the last step S27, the controller 30 determines the rotation speed of the blower 9 and the opening of the first air distribution valve 10 according to the calculated air increase amount, and operates the blower 9 and the first air distribution valve 10 accordingly. Further, it increases the target fuel injection amount of the fuel injector 1 according to the fuel increase amount calculated in the step S22 and the additional fuel amount calculated in the step S25.

In the first embodiment, the heat amount equivalent to the latent heat amount of the increased fuel was made up by the heat generated by the electric heater 4, but in this embodiment, heat amount insufficiency is compensated by increasing the fuel supply amount and air supply amount. According to this method, the air heating amount can be increased by the heat exchanger 6 corresponding to the fuel increase amount without using the electric heater 4.

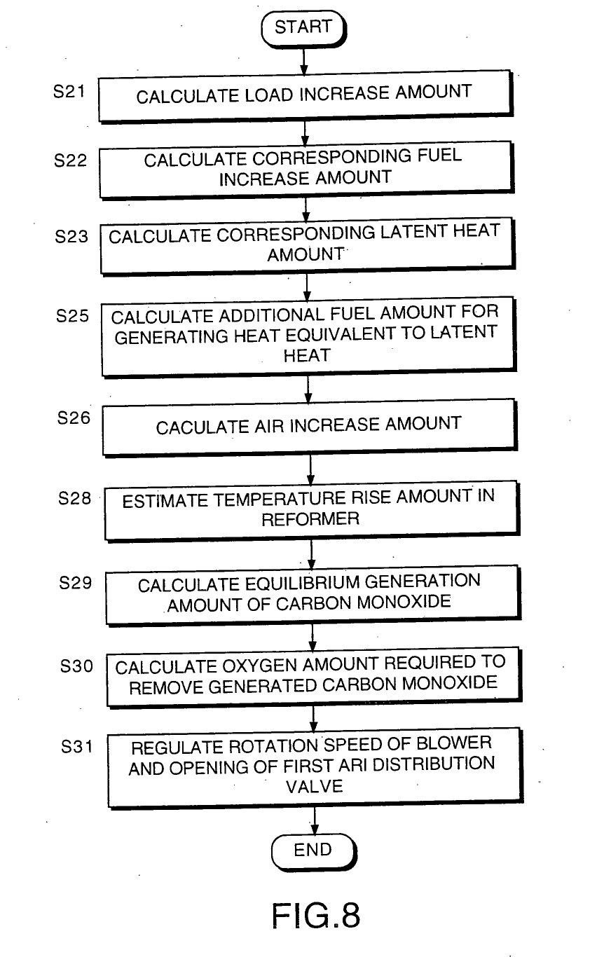

Next, referring to FIG. 8, a third embodiment of this invention will be described.

This embodiment relates to control when there is a load increase. The controller 30 performs a routine of FIG. 8 instead of the routine of FIG. 7 of the second embodiment. In this routine, the processing of steps S28-S31 is performed after execution of the step S26 of the routine of FIG. 7. The processing of the other steps is identical to that of the routine of FIG. 7.

In the step S28, the temperature rise amount in the reformer 5 is estimated based on the increased amount of fuel and increased amount of air in the previous steps S21-S26.

In the following step S29, the controller 30 calculates the equilibrium generation amount of carbon monoxide based on the estimated temperature in the reformer 5, the fuel injection amount and the air supply amount determined in the step S21-S26.

In the following step S30, the controller 30 calculates the oxygen amount required to remove the generated carbon monoxide. In the last step S31, the controller 30 regulates the rotation speed of the blower 9 and the opening of the first air distribution valve 10 such that the air increase amount calculated in the step S26 and the oxygen amount calculated in the step S30 are additionally supplied. Further, it increases the target fuel injection amount according to the fuel increase amount calculated in the step S22 and the additional fuel amount calculated in the step S25.

The allowable concentration of carbon monoxide in the reformate gas depends on a poisoning deterioration limiting value of the electrolyte membrane of the fuel cell used by the fuel cell power plant. In the step S30, the required oxygen amount is calculated so that the carbon monoxide concentration in the reformate gas is less than the poisoning deterioration limiting value.

According to this embodiment, not only an enhanced performance of the heat exchanger 6 to deal with the increase of fuel injection amount, but also the prevention of an increase in the generation of carbon monoxide accompanied with the increase in the fuel injection amount by increasing the air supply amount to the PROX reactor 8, are realized. Therefore, according to this embodiment, even when the power generation load increases, the carbon monoxide concentration in the reformate gas can be maintained in a desirable range below the allowable limit.

Next, referring to FIG. 9, a fourth embodiment of this invention will be described.

This embodiment relates to the control when the operation of the fuel reforming device is terminated. When the fuel cell power plant stops operation, the controller 30 performs the routine of FIG. 9 instead of the routine of FIG. 6 of the first embodiment. In this routine, a step S43 is provided instead of the step S42 of the routine of FIG. 6.

In the step S43, the controller 30 maximizes the air supply amount of the blower 9, and energizes the electric heater 4. After allowing this state to continue for a predetermined time period, operation of the blower 9 and energization of the electric heater 4 are stopped.

According to this embodiment, the fuel remaining inside the device is heated by the electric heater 4, so the remaining fuel can be oxidized with greater certainty.

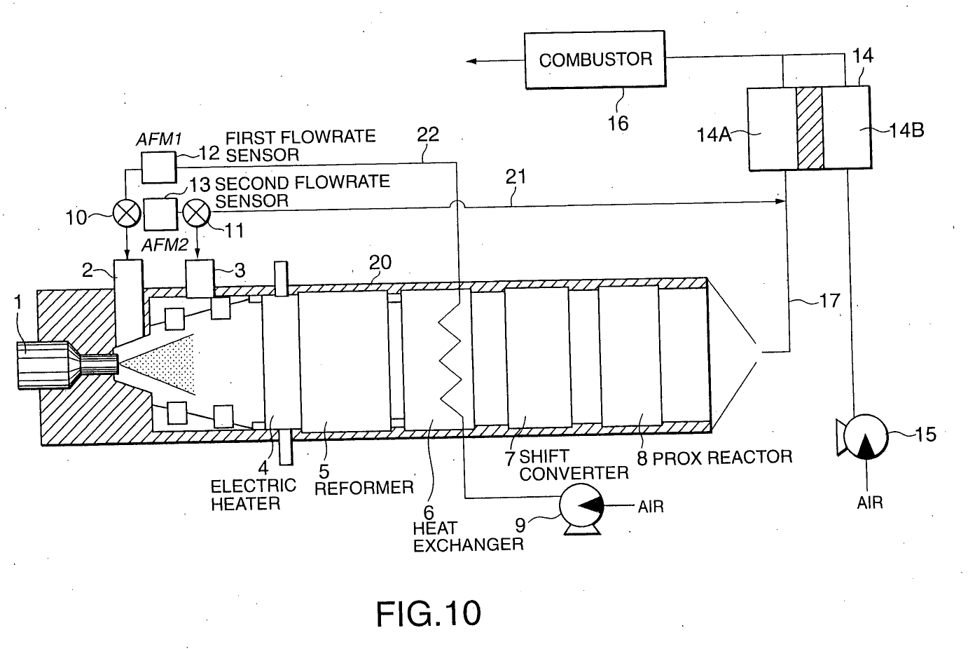

Next, referring to FIG. 10, a fifth embodiment of this invention will be described.

This embodiment relates to the construction of the fuel cell power plant, the fuel cell power plant comprising a fuel cell stack 14 comprising a stack 14 of fuel cells which generate power according to an electrochemical reaction between hydrogen supplied to an anode 14A, and oxygen supplied to a cathode 14B. The reformate gas generated by the fuel reforming device is supplied to the anode 14A via a reformate gas supply passage 17, and air is supplied to the cathode 14B from a blower 15. Due to power generation by the fuel cell stack 14, anode effluent containing hydrogen is discharged from the anode 14A, and cathode effluent containing air is discharged from the cathode 14B. After burning these effluents in a combustor 16, they are discharged into the air.

In this embodiment, the air supply passage 21 is connected to the reformate gas supply passage 17 instead of connecting it to the PROX reactor 8 as in the case of the first embodiment.

Immediately after the fuel reforming device has shifted from warm-up to reforming operation, the reforming reaction is not stable, and carbon monoxide and unburnt hydrocarbon fuel may flow into the reformate gas supply passage 17. As a result, the concentration of carbon monoxide in the reformate gas may exceed the allowable limit. According to this embodiment, however, the air supplied to the reformate gas supply passage 17 from the air supply passage 21 dilutes the concentration of carbon monoxide in the reformate gas, so the deterioration of the catalyst with which the anode 14A is provided is prevented.

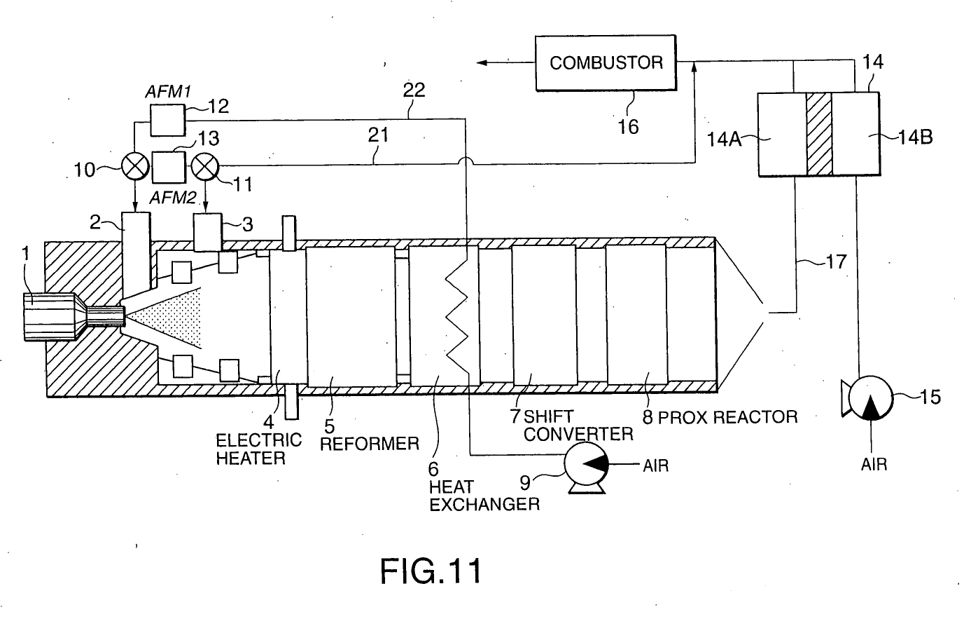

Next, referring to FIG. 11, a sixth embodiment of this invention will be described.

This embodiment relates to the construction of the fuel cell power plant. In this embodiment, the air supply passage 21 is connected to the combustor 16 instead of connecting the air supply passage 21 to the reformate gas supply passage 17 as in the fifth embodiment.

In this embodiment, reformate gas containing carbon monoxide and unburnt hydrocarbon fuel produced immediately after the fuel reforming device has shifted from warm-up to reforming operation, is diluted by the air supplied from the air supply passage 21, and discharged into the air in a completely oxidized state by burning in the combustor 16.

In this embodiment, as carbon monoxide and unburnt hydrocarbon fuel temporarily flow into the anode 14A of the fuel cell stack 14, the anode 14A must be constructed from a material having high resistance to carbon monoxide and unburnt hydrocarbon fuel.

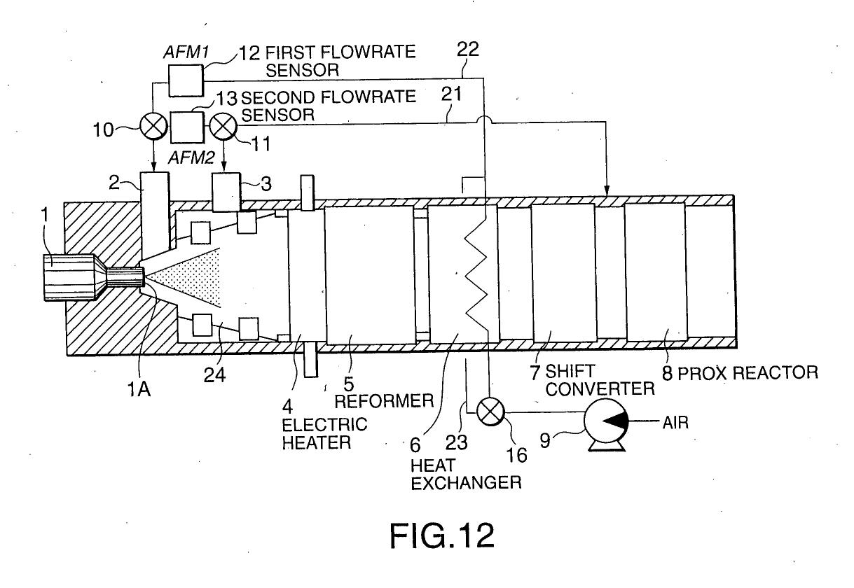

Next, referring to FIG. 12, a seventh embodiment of this invention will be described.

This embodiment relates to the construction of the fuel reforming device. A third air distribution valve 13 is provided midway in the air supply passage 22 from the blower 9 to the heat exchanger 6, and a bypass passage 23 branches off from the third air distribution valve 13. The bypass passage 23 bypasses the heat exchanger 6, and rejoins the air supply passage 22 again between the heat exchanger 6 and the first flowrate sensor 12. The remaining features of the construction of the fuel reforming device are identical to those of the first embodiment.

During normal operation, the heat exchanger 6 warms the air sent out from the blower 9, which is supplied to the fuel reforming device. On the other hand, when operation stops, the third air distribution valve 13 is operated to supply all of the air from the blower 9 to the fuel reforming device via the bypass passage 23 without heating.

As a result, the fuel injector 1 is cooled by the cool air supplied from the first air supply port 2. After fuel remaining at the tip of the fuel injector 1 is blown away by this air and undergoes reforming and oxidation in the reformer 5, it is discharged into the air. Therefore, worsening of the exhaust gas composition when operation of the fuel reforming device is stopped or re-started, can be prevented.

The contents of Tokugan 2002-180433, with a filing date of Jun. 20, 2002 in Japan, are hereby incorporated by reference.

Although the invention has been described above by reference to certain embodiments of the invention, the invention is not limited to the embodiments described above. Modifications and variations of the embodiments described above will occur to those skilled in the art, in light of the above teachings.

For example, the processing for load increase or stopping of operation of the second-fourth embodiments can be combined with the fifth embodiment or sixth embodiment.

### INDUSTRIAL FIELD OF APPLICATION

According to this invention, the warm-up time period of the fuel reforming device is shortened, so the invention has preferable effects when it is applied to the reforming device of a fuel cell power plant for a vehicle.

1. A fuel reforming device which generates reformate gas comprising hydrogen by reforming a mixture of a hydrocarbon fuel and air, comprising:
a fuel mixing chamber;
a fuel injector which injects the hydrocarbon fuel into the fuel mixing chamber;
a first air distribution valve which supplies air to the fuel mixing chamber and generates an air-fuel mixture;
a second air distribution valve which further supplies air to the air-fuel mixture in the fuel mixing chamber; and
a reformer comprising a reforming catalyst which generates reformate gas by causing the air-fuel mixture supplied from the fuel mixing chamber to undergo reforming reaction, and an oxidation catalyst which causes the air-fuel mixture to undergo a catalytic combustion.

2. The fuel reforming device as defined in claim 1, wherein the fuel reforming device further comprises a heater which heats the fuel-air mixture, and a controller functioning to control the heater to heat the fuel-air mixture when the fuel reforming device starts operation, and control an air supply amount of the first air distribution valve to the fuel mixing chamber to maintain an excess air factor of the air-fuel mixture in a predetermined lean state.

3. The fuel reforming device as defined in claim 2, wherein the fuel reforming device further comprises a sensor which detects a temperature of the reformer, and the controller further functions to determine whether or not the temperature of the reformer is ascending in a state where the air-fuel mixture heated by the heater is supplied to the reformer, and when the temperature of the reformer is ascending, control the heater to stop heating the air-fuel mixture.

4. The fuel reforming device as defined in claim 3, wherein the controller further functions to determine whether or not the temperature of the reformer is less than a predetermined temperature, to increase a fuel injection amount of the fuel injector with a preset increment, to increase the air supply amount with a preset increment, to determine whether or not an ascending rate of the temperature of the reformer exceeds a predetermined rate in a state where the temperature of the reformer is less than the predetermined temperature, and when the ascending rate exceeds the predetermined rate, and to decrease the increment of the fuel injection amount and the increment of the air supply amount.

5. The fuel reforming device as defined in claim 4, wherein the controller further functions, when the temperature of the reformer is not less than the predetermined temperature, to decrease the air supply amount of the first air distribution valve until the air excess factor of the air-fuel mixture reaches a predetermined rich state, increase the air supply amount of the second air distribution valve to the fuel mixing chamber so as to compensate for the decrease of the air supply amount of the first air distribution valve, and then close the second air distribution valve.

6. The fuel reforming device as defined in claim 1, wherein the fuel reforming device further comprises an air supply mechanism which supplies air to the first air distribution valve and the second air distribution valve, and a heat exchanger which heats the air between the air supply mechanism and the first air distribution valve by performing heat exchange between the air and a gas discharged from the reformer.

7. The fuel reforming device as defined in claim 1, wherein the fuel reforming device further comprises an air supply mechanism which supplies air to the first air distribution valve, and a carbon monoxide removal device which removes carbon monoxide from the reformate gas by a catalytic reaction using air, the first air distribution valve is configured to bifurcate the air supplied from the air supply mechanism to the fuel mixing chamber and the second air distribution valve, and the second air distribution valve is configured to bifurcate air supplied from the first air distribution valve to the fuel mixing chamber and to the carbon monoxide removal device.

8. The fuel reforming device as defined in claim 1, wherein the fuel reforming device is used together with a fuel cell stack comprising an anode and a cathode, and generating power by an electrochemical reaction between hydrogen in the reformate gas supplied to the anode and oxygen supplied to the cathode, the fuel reforming device comprises an air supply mechanism which supplies air to the first air distribution valve, the first air distribution valve is configured to bifurcate the air supplied from the air supply mechanism to the fuel mixing chamber and the second air distribution valve, and the second air distribution valve is configured to bifurcate the air supplied from the first air distribution valve to the fuel mixing chamber and the anode.

9. The fuel reforming device as defined in claim 1, wherein the fuel reforming device is used together with a fuel cell stack, comprising an anode and a cathode, and generating power by the electrochemical reaction between hydrogen in the reformate gas supplied to the anode and oxygen supplied to the cathode, and a combustor which burns an anode effluent discharged from the anode, the fuel reforming device comprises an air supply mechanism which supplies air to the first air distribution valve, the first air distribution valve is configured to bifurcate the air supplied from the air supply mechanism to the fuel mixing chamber and the second air distribution valve, and the second air distribution valve is configured to bifurcate the air supplied from the first air distribution valve to the fuel mixing chamber and the combustor.

10. The fuel reforming device as defined in claim 1, wherein the fuel reforming device is used together with a fuel cell stack which generates electric power according to a power generation load using hydrogen in the reformats gas supplied by the fuel reforming device, and the fuel reforming device further comprises a heater which heats the air-fuel mixture, a sensor which detects the power generation load, and a controller functioning to calculate an increase amount of hydrocarbon fuel corresponding to an increase amount of the power generation load, to calculate a latent heat amount for vaporizing the increase amount of hydrocarbon fuel, and to control the heater to heat the air-fuel mixture for compensating the latent heat amount.

11. The fuel reforming device as defined in claim 1, wherein the fuel reforming device is used together with a fuel cell stack which generates electric power according to a power generation load using hydrogen in the reformate gas supplied by the fuel reforming device, and the fuel reforming device further comprises an air supply mechanism which supplies air to the first air distribution valve, a sensor which detects the power generation load, and a controller functioning to calculate a first increase amount of hydrocarbon fuel corresponding to an increase amount of the power generation load, to calculate a latent heat amount for vaporizing the first increase amount of hydrocarbon fuel, to calculate a second increase amount of hydrocarbon fuel for compensating the latent heat amount by a catalytic combustion of the second increase amount of hydrocarbon fuel, to increase a fuel injection amount of the fuel injector according to the sum of the first increase amount of hydrocarbon fuel and the second increase amount of hydrocarbon fuel, and to control the air supply mechanism and the first air distribution valve to increase an air supply amount to the fuel mixing chamber according to an increased fuel injection amount by the fuel injector.

12. The fuel reforming device as defined in claim 11, wherein the fuel reforming device further comprises a carbon monoxide removal device which removes carbon monoxide from the reformate gas by a catalytic reaction using air, the first air distribution valve is configured to bifurcate the air supplied from the air supply mechanism to the fuel mixing chamber and the second air distribution valve, the second air distribution valve is configured to bifurcate air supplied from the first distribution valve to the fuel mixing chamber and the carbon monoxide removal device, and the controller further functions to estimate a temperature ascending amount of the reformer from the increased fuel injection amount by the fuel injector and an increased air supply amount to the fuel mixing chamber, to calculate a generated amount of carbon monoxide in the reformer corresponding to the increased fuel injection amount and the increased air supply amount, and to control the air supply mechanism and the second air distribution valve to supply a required amount of air to the carbon monoxide removal device which the carbon monoxide removal device requires for removing carbon monoxide of the generated amount from the reformate gas.

13. The fuel reforming device as defined in claim 1, wherein the fuel reforming device further comprises a switch which commands the fuel reforming device to start and stop operation, an air supply mechanism which supplies air to the first air distribution valve, and a controller functioning, when the switch has commanded the reforming device to stop operation, to stop injection of hydrocarbon fuel by the fuel injector, and to maximize an air supply amount of the air supply mechanism.

14. The fuel reforming device as defined in claim 1, wherein the fuel reforming device further comprises a switch which commands the fuel reforming device to start and stop operation, an air supply mechanism which supplies air to the first air distribution valve, a heater which heats the air-fuel mixture, and a controller functioning, when the switch has commanded the fuel reforming device to stop operation, to stop injection of hydrocarbon fuel by the fuel injector, to maximize an air supply amount of the air supply mechanism, and to activate the heater to heat the air-fuel mixture.

15. The fuel reforming device as defined in claim 1, wherein the fuel reforming device further comprises an air supply mechanism which supplies air to the first air distribution valve, a heat exchanger which warms an air supplied by the air supply mechanism to the first air distribution valve by heat exchange with the reformate gas, and a bypass passage which connects the air supply mechanism with the first air distribution valve bypassing the heat exchanger.
